(19) United States
(12) Patent Application Publication
(10) Pub. No.: US 2014/0025383 A1
(43) Pub. Date: Jan. 23, 2014

(54) Voice Outputting Method, Voice Interaction Method and Electronic Device

(71) Applicant: Lenovo (Beijing) Co., Ltd., Beijing (CN)

(72) Inventors: Haisheng Dai, Beijing (CN); Qianying Wang, Beijing (CN); Hao Wang, Beijing (CN)

(21) Appl. No.: 13/943,054

(22) Filed: Jul. 16, 2013

(30) Foreign Application Priority Data
Jul. 17, 2012 (CN) CN201210248179.3

(51) Int. Cl. G10L 13/00

(52) U.S. Cl. CPC G10L 13/00
USPC 704/260

(57) ABSTRACT

A voice outputting method, a voice interaction method and an electronic device are described The method includes acquiring a first content to be output; analyzing the first content to acquire a first emotion information for expressing the emotion carried by the first content to be output; acquiring a first voice data to be output corresponding to the first content; processing the first voice data to be output based on the first emotion information to generate a second voice data to be output with a second emotion information, wherein the second emotion information is used to express the emotion of the electronic device outputting the second voice data to be output to enable the user to acquire the emotion of the electronic device, and wherein the first and the second emotion information are matched to and/or correlated to each other; outputting the second voice data to be output.

This application claims priority to Chinese patent application No. CN201210248179.3 filed on Jul. 17, 2012, the entire contents of incorporated herein by reference.

The present invention relates to the field of computer technology, in particular, relates to a voice outputting method, a voice interaction method and an electronic device.

### BACKGROUND

With the development of the electronics device and voice recognition technology, the interaction between the user and the electronics device are becoming increasingly popular, the electronics device can convert a text information into voice output, and the user and the electronics device can interact via voice. For example, the electronics device can answer the question raised by the user, which makes the electronics device more and more humanized.

However, the inventor finds out that although the electronics device can recognize the user's voice to perform a corresponding operation or convert text into voice output or make a voice chatting with the user, the voice interaction system or the voice information of the electronics device in the voice output system in the prior art fail to carry any information relating to emotion expression, which further leads to a voice output without any emotion. Thus, the conversion is monotonous and the efficiency of the voice control and the Human-Machine interaction is low, which deteriorates the user's experience.

### SUMMARY

The present invention provides a voice outputting method, a voice interaction method and an electronic device, for addressing the technical problem that the voice data output from the electronics device in the prior art fail to carry any information relating to emotion expression and the technical problem that the emotion during the Human-Machine interaction is monotonous which deteriorates the user's experience.

According to one aspect of the present invention, there is provided a voice output method applied in an electronic device, the method comprises: acquiring a first content to be output; analyzing the first content to be output to acquire a first emotion information for expressing the emotion carried by the first content to be output; acquiring a first voice data to be output corresponding to the first content to be output; processing the first voice data to be output based on the first emotion information to generate a second voice data to be output with a second emotion information, wherein the second emotion information is used to express the emotion of the electronic device outputting the second voice data to be output to enable the user to acquire the emotion of the electronic device, and wherein the first emotion information and the second emotion information are matched to/correlated to each other; outputting the second voice data to be output.

Preferably, acquiring a first content to be output is: acquiring the voice data received via an instant message application; acquiring the voice data input via the voice input means of the electronic device; or acquiring the text information displayed on the display unit of the electronic device.

Preferably, when the first content to be output is the voice data, analyzing the first content to be output to acquire a first emotion information comprises: comparing the audio spectrum of the voice data with every characteristic spectrum template among the M characteristic spectrum templates respectively to acquire the M comparison results of the audio spectrum of the voice data against every characteristic spectrum template, wherein M is a integral greater than 2; determining the characteristic spectrum template among the M characteristic spectrum templates having the highest similarity with the voice data based on the M comparison results; determining the emotion information corresponding to the characteristic spectrum template having the highest similarity as the first emotion information.

Preferably, processing the first voice data to be output based on the first emotion information to generate a second voice data to be output with a second emotion information comprises: adjusting the tone, the volume of the words corresponding to the first voice data to be output or the pause time between words to generate the second voice data.

According to another aspect of the present invention, there is provided a voice interaction method applied in an electronic device, the method comprises: receiving a first voice data input by a user; analyzing the first voice data to acquire a first emotion information, wherein the first emotion information is used to express the emotion of the user when the user input the first voice data; acquiring a first response voice data with respect to the first voice data; processing the first response voice data based on the first emotion information to generate a second response voice data with a second emotion information; the second emotion information is used to express the emotion of the electronic device outputting the second voice data to be output to enable the user to acquire the emotion of the electronic device, and wherein the first emotion information and the second emotion information are matched to/correlated to each other; outputting the second response voice data.

Preferably, analyzing the first voice data to acquire a first emotion information comprises: comparing the audio spectrum of the first voice data with every characteristic spectrum template among the M characteristic spectrum templates respectively to acquire the M comparison results of the audio spectrum of the voice data against every characteristic spectrum template, wherein M is a integral greater than 2; determining the characteristic spectrum template among the M characteristic spectrum templates having the highest similarity with the voice data based on the M comparison results; determining the emotion information corresponding to the characteristic spectrum template having the highest similarity as the first emotion information.

Preferably, analyzing the first voice data to acquire a first emotion information comprises: determining whether the times of the consecutive input are larger than a predetermined value; when the times of the consecutive input are larger than a predetermined value, determining the emotion information in the first voice data as the first emotion information.

Preferably, processing the first response voice data based on the first emotion information to generate a second response voice data with a second emotion information comprises: adjusting the tone, the volume of the words corresponding to the first response voice data to be output or the pause time between words to generate the second response voice data.

Preferably, processing the first response voice data based on the first emotion information to generate a second response voice data with a second emotion information comprises: adding the voice data expressing the second emotion information to the first response voice data based on the first emotion information to acquire the second response voice data.

According to another aspect of the present invention, there is provided an electronic device, the electronic device comprises: a circuit board; an acquiring unit electrically connected to the circuit board for acquiring a first content to be output; a processing chip set on the circuit board for analyzing the first content to be output to acquire a first emotion information for expressing the emotion carried by the first content to be output; acquiring a first voice data to be output corresponding to the first content to be output; processing the first voice data to be output based on the first emotion information to generate a second voice data to be output with a second emotion information, wherein the second emotion information is used to express the emotion of the electronic device outputting the second voice data to be output to enable the user to acquire the emotion of the electronic device, and wherein the first emotion information and the second emotion information are matched to/correlated to each other; an output unit electrically connected to the processing chip 303 for outputting the second voice data to be output.

Preferably, when the first content to be output is the voice data, the processing chip is used to compare the audio spectrum of the voice data with every characteristic spectrum template among the M characteristic spectrum templates respectively to acquire the M comparison results of the audio spectrum of the voice data against every characteristic spectrum template, wherein M is a integral greater than 2; determine the characteristic spectrum template among the M characteristic spectrum templates having the highest similarity with the voice data based on the M comparison results; determine the emotion information corresponding to the characteristic spectrum template having the highest similarity as the first emotion information.

Preferably, the processing chip is used to adjust the tone, the volume of the words corresponding to the first voice data to be output or the pause time between words to generate the second voice data.

According to another aspect of the present invention, there is provided an electronic device, the electronic device comprises: a circuit board; a voice receiving unit electrically connected to the circuit board for receiving a first voice input of a user; a processing chip set on the circuit board for analyzing the first voice data to acquire a first emotion information, wherein the first emotion information is used to express the emotion of the user when the user input the first voice data; acquiring a first response voice data with respect to the first voice data; processing the first response voice data based on the first emotion information to generate a second response voice with a second emotion information; the second emotion information is used to express the emotion of the electronic device outputting the second voice data to be output to enable the user to acquire the emotion of the electronic device, and wherein the first emotion information and the second emotion information are matched to/correlated to each other; an output unit electrically connected to the processing chip for outputting the second response voice data.

Preferably, the processing chip is used to compare the audio spectrum of the first voice data with every characteristic spectrum template among the M characteristic spectrum templates respectively to acquire the M comparison results of the audio spectrum of the voice data against every characteristic spectrum template, wherein M is a integral greater than 2; determine the characteristic spectrum template among the M characteristic spectrum templates having the highest similarity with the voice data based on the M comparison results; determine the emotion information corresponding to the characteristic spectrum template having the highest similarity as the first emotion information.

Preferably, the processing chip is used to determine whether the times of the consecutive input are larger than a predetermined value; when the times of the consecutive input are larger than a predetermined value, determine the emotion information in the first voice data as the first emotion information.

Preferably, the processing chip is used to adjust the tone, the volume of the words corresponding to the first response voice data to be output or the pause time between words to generate the second response voice data.

Preferably, the processing chip is used to add the voice data expressing the second emotion information to the first response voice data based on the first emotion information to acquire the second response voice data.

The embodiments of the present invention provide one or more technical solutions and at least the technical effects or advantages as follows:

According to an embodiment of the present invention, the emotion information of the content to be output (for example SMS message or other text information, or the voice data received via an instant message software, or the voice data input via the voice input means of the electronic device), then the voice data to be output corresponding to the content to be output is processed based on the emotion information to acquire the voice data to be output with a second emotion information. Thus, when the electronic device outputs the voice data to be output with the second emotion information, the user can acquire the emotion of the electronic device. Therefore, the electronic device can output the voice information with different emotions according to different contents or scenes, which helps the user understand the emotion of the electronic device more clearly, thus the efficiency of the voice output is enhanced and the user's experience is improved.

According to another embodiment of the present invention, when the user inputs a first voice data, the first voice data is analyzed to acquire the corresponding first emotion, and then a first response voice data with respect to the first voice data is acquired. Next, a processing is performed on the first response voice data based on the first emotion information to generate a second response voice with a second emotion information which enable the user to acquire the emotion of the electronic device when the second response voice data is output. Thus, a better Human-Machine interaction is realized and the electronic device is more humanized so that the Human-Machine interaction is efficient and the user's experience is improved.

### BRIEF DESCRIPTION OF THE DRAWINGS

FIG. 1 is a method flowchart of voice output in the first embodiment of the present invention;

FIG. 2 is a method flowchart of voice interaction in the second embodiment of the present invention;

FIG. 3 is a functional block diagram of an electronic device in the first embodiment of the present invention;

FIG. 4 is a functional block diagram of an electronic device in the second embodiment of the present invention.

### DETAILED DESCRIPTION

An embodiment of the present invention provides a voice outputting method, a voice interaction method and an electronic device, for addressing the technical problem in the prior art that the voice data output from the electronics device fail to carry any information relating to emotion expression and the technical problem that the emotion during the Human-Machine interaction is monotonous which deteriorates the user's experience.

The technical solutions in the embodiments of the present invention aim to solve the above-mentioned technical problems, and the general idea is as follows:

The voice data to be output or input by the user are analyzed to acquire the first emotion corresponding to the voice data to be output or input by the user, then the voice data are acquired with respect to the content to be output or the first voice data, the voice data are processed based on the first emotion information to generate the voice data with the second emotion information, thus the user can acquire the emotion of the electronic device when the voice data with the second emotion information are output. The electronic device can output the voice information with different emotions according to different contents or scenes, which helps the user understand the emotion of the electronic device more clearly and the efficiency of the voice output is enhances. Therefore, the human and the machine can interact in a better manner, the electronic is more humanized which leads to a higher efficiency of the Human-Machine and enhances the user's experience.

For a better understanding of the technical solutions, the technical solutions will be described in detail with reference to the appended drawings and the embodiments.

An embodiment of the present invention provides a voice output method applied in an electronic device such as a mobile phone, a tablet computer or a notebook computer.

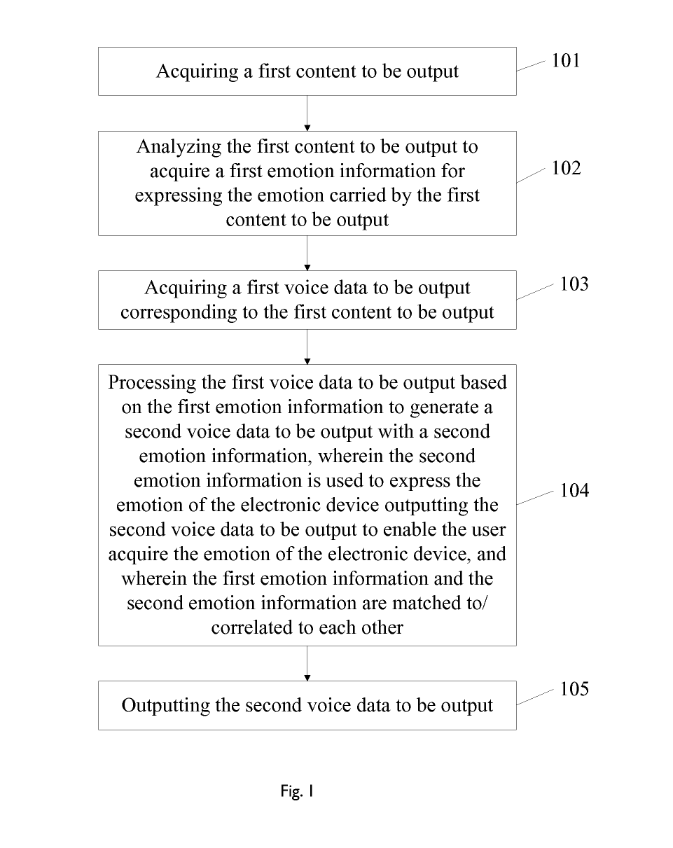

With reference to FIG. 1, the method comprises:

Step 101: Acquiring a first content to be output;

Step 102: Analyzing the first content to be output to acquire a first emotion information for expressing the emotion carried by the first content to be output;

Step 103: Acquiring a first voice data to be output corresponding to the first content to be output;

Step 104: Processing the first voice data to be output based on the first emotion information to generate a second voice data to be output with a second emotion information, wherein the second emotion information is used to express the emotion of the electronic device outputting the second voice data to be output to enable the user to acquire the emotion of the electronic device, and wherein the first emotion information and the second emotion information are matched to/correlated to each other.

Step 105: Outputting the second voice data to be output.

Wherein, the first emotion information and the second emotion information are matched to/correlated to each other. For example, it is possible that the second emotion is used to enhance the first emotion; also it is possible that the second emotion is used to alleviate the first emotion. Of course, the other forms of matching or correlating rules can be set in the detailed implementations.

Wherein, in Step 101, in the detailed implementation, the first content to be output acquired can be the voice data received via a instant message application, for example, the voice data received via a chatting software such as MiTalk,WeChat; also it can be the voice data input via the voice input means of the electronic device; also it can be the text information displayed on the display unit of the electronic device, for example, the text information of a SMS, an electronic book or a webpage.

Wherein, Step 102 and Step 103 go in no particular order. In the following description, Step 102 is performed firstly by way of example, but in a practical implementation, Step 103 can also be performed firstly.

Next, Step 102 is performed. In this step, if the first content to be output is text information, the first content to be output is analyzed to acquire the first emotion information. Specifically, a linguistic analysis is performed with respect to the text, that is, the analysis of wording, grammar and semantics are performed sentence by sentence to determine the structure of the sentence and the composition of phoneme of each word, which include but are not limited to the sentence segmentation of the text, the word segmentation, the processing of polyphone, the processing of number, the processing of acronym. For instance, the punctuation of text can be analyzed to determine it is a interrogative sentence, a declarative sentence or a exclamatory sentence, thus the emotion carried by the text can be acquired in a relative simple manner according to the meaning of the words per se and the punctuations.

Specifically, the text information is “Oh, I am so happy!” for instance, thus by the analysis of the above method, the word “happy” itself represents an emotion of happiness, the interjection of “Oh” further expresses that the emotion of happiness is strong, then there is a exclamation mark which further enhances the emotion of happiness. Thus, the emotion carried by the text can be acquired via the analysis of these pieces of information, that is, the first emotion is acquired.

Then, Step 103 is performed to acquire the first voice data to be output corresponding to the first content to be output. That is, the words, the word groups or the phrases corresponding to the text are extracted from the voice synthesis library to form the first voice data to be output, wherein the voice synthesis library can be the existing voice synthesis library which is generally stored in the electronic device in advance or can also be stored in a server on the network so that the words, the word groups or the phrases corresponding to the text can be extracted from the voice synthesis library of the server via network when the electronic device is connected to the network.

Next, Step 104 is performed to process the first voice data to be output based on the first emotion information so as to generate the second voice data to be output with the second emotion information. Specifically, the tone, the volume of the words corresponding to the first voice data to be output or the pause time between words can be adjusted. Continue to use the example above, the voice volume corresponding to “happy” can be increased, the tone of the interjection of “Oh” can be enhanced, and the pause time between the adverb of degree “so” and the subsequent “happy” can be lengthened to enhance the degree of the happiness emotion.

As for the device side, there are many implementations to adjust the above-mentioned tone, volume or pause time between the words. For example, some kind of models are trained in advance, that is, with respect to the words expressing emotion such as “happy”, “sad”, “glad”, it can be trained to increase the volume; with respect to the interjection, it can be trained to enhance the tone; it can also be trained to lengthen the pause time between the adverb of degree and the subsequent adjective or verb, and to lengthen the pause time between the adjective and the subsequent noun. Therefore, the adjustment is performed according to the model, and the detailed adjustment can be the adjustment of the audio spectrum of the corresponding voice.

When the second voice data to be output are output, the user can acquire the emotion of the electronic device. In the embodiment, the emotion of the human sending the SMS message can be acquired so that the user can use the electronic device more efficiently, and it is more humanized to facilitate an efficient communication between users.

In another embodiment, when the first content to be output acquired in Step 101 is the voice data received via an instant message application or the voice data input via the voice input means of the electronic device, in Step 102, the voice data is analyzed to acquire the first emotion information by the method as follows.

The audio spectrum of the voice data is compared with every characteristic spectrum template among the M characteristic spectrum templates respectively to acquire the M comparison results of the audio spectrum of the voice data against every characteristic spectrum template, wherein M is a integral greater than 2; then the characteristic spectrum template among the M characteristic spectrum templates having the highest similarity with the voice data is determined based on the M comparison results; the emotion information corresponding to the characteristic spectrum template having the highest similarity is determined as the first emotion information.

In a specific implementation, the M characteristic spectrum templates are trained in advance, that is, the audio characteristic spectrum of the emotion of happiness is obtained by a plenty of trains, and a plurality of characteristic spectrum templates can be obtained in the same way. Thus, when the voice data of the first content to be output are acquired, the audio spectrum of the voice data is compared with the M characteristic spectrum templates to obtain the similarity with every characteristic spectrum template, and the emotion corresponding to the characteristic spectrum template with the highest similarity value is the emotion corresponding to the voice data, thus the first emotion information is acquired.

After the first emotion information is acquired, Step 103 is performed, in the present embodiment, since the first content to be output is the voice data, Step 103 is omitted and the processing proceeds to Step 104.

In another embodiment, Step 103 can also be adding voice data to the original voice data. Continue to use the example above, when the voice data acquires is “I am so happy!”, in Step 103, the voice data of “Yeah, I am so happy!” can be acquired to further express the emotion of happiness.

With regard to Step 104 and Step 105 which are similar with the above first embodiment, the repeated description is omitted here.

Another embodiment of the present invention provides a voice interaction method applied in an electronic device, with reference to FIG. 1, the method comprises:

Step 201: Receiving a first voice data input by the user;

Step 202: Analyzing the first voice data to acquire a first emotion information, wherein the first emotion information is used to express the emotion of the user when the user input the first voice data;

Step 203: Acquiring a first response voice data with respect to the first voice data;

Step 204: A processing is performed on the first response voice data based on the first emotion information to generate a second response voice with a second emotion information; the second emotion information is used to express the emotion of the electronic device outputting the second voice data to be output to enable the user to acquire the emotion of the electronic device, and wherein the first emotion information and the second emotion information are matched to/correlated to each other.

Step 205: Outputting the second response voice data to be output.

Wherein, the first emotion information and the second emotion information are matched to/correlated to each other. For example, it is possible that the second emotion is used to enhance the first emotion; also it is possible that the second emotion is used to alleviate the first emotion. Of course, the other forms of matching or correlating rules can be set in the detailed implementations.

The voice interaction method of the present embodiment can be applied to a conversation system or an instant message software for example, and can also be applied to a voice control system. Of course, the application scenarios are only exemplary and do not intend to limit the present application.

Next, the detailed implementation of the voice interaction method will be described by way of example.

In the present embodiment, for instance, the user inputs a first voice data “How is the weather today?” into the electronic device via a microphone. Then, Step 202 is performed, that is, the first voice data is analyzed to acquire the first emotion information. The step can also adopt the analysis manner in the above-mentioned second embodiment to analyze, that is, the audio spectrum of the first voice data is compared with every characteristic spectrum template among the M characteristic spectrum templates respectively to acquire the M comparison results of the audio spectrum of the voice data against every characteristic spectrum template, wherein M is a integral greater than 2; then the characteristic spectrum template among the M characteristic spectrum templates having the highest similarity with the voice data is determined based on the M comparison results; the emotion information corresponding to the characteristic spectrum template having the highest similarity is determined as the first emotion information.

In a specific implementation, the M characteristic spectrum templates are trained in advance, that is, the audio characteristic spectrum of the emotion of happiness is obtained by a plenty of trains, and a plurality of characteristic spectrum templates can be obtained in the same way. Thus, when the first voice data are acquired, the audio spectrum of the first voice data is compared with the M characteristic spectrum templates to obtain the similarity with every characteristic spectrum template, and the emotion corresponding to the characteristic spectrum template with the highest similarity value is the emotion corresponding to the first voice data, thus the first emotion information is acquired.

Assume that the first emotion is a depressed emotion, that is, the user is depressed when entering the first voice information.

Next, Step 203 is performed to acquire a first response voice data with respect to the first voice data, but Step 203 can also be performed before Step 202 of course. Continue to use the example above, what the user input is “How is the weather today?”, then the electronic device acquires the weather information in real time via network, and converts the weather information into the voice data, thus the corresponding sentence is “It's a fine day today, the temperature is 28° C. which is appropriate for travel”.

Then, based on the first emotion information acquired in Step 202, a processing is performed on the first response voice data. In the present embodiment, the first emotion information expresses a depressed emotion which means the user is in a poor mental state and lacks of motivation. Thus, in an embodiment, the tone, the volume of the words or the pause time between words corresponding to the first response voice data can be adjusted, so that the second response voice data to be output is in a bright and high spirits tone, that is, the user feels the sentence output from the electronic device is pleasant, which will help the user to improve the negative emotion.

With regard to the detailed adjustment rules, the adjustment rules in the above-mentioned embodiments are referenced. For example, the audio spectrum of adjective “fine” is changed so that the tone and volume of the adjective express a high spirit.

In another embodiment, Step 204 can be adding the voice data expressing the second emotion information to the first response voice data based on the first emotion information as so to acquire the second response voice data.

Specifically, it is possible to adding some modal particle. For instance, the sentence of “It's a fine day today, the temperature is 28° C. which is appropriate for travel” is adjusted to “Yeah, It's a fine day today, the temperature is 28° C. which is appropriate for travel”. That is, the voice data of “yeah” is extracted from the voice synthesis library, then it is synthesized to the first response voice data to form the second response voice data. Of course, the above-mentioned two different adjustment manners can be used in conjunction with each other.

In a further embodiment, when the first voice data is analyzed to acquire the first emotion information in Step 202, it is also possible to determine whether the times of the consecutive input are larger than a predetermined value; when the times of the consecutive input are larger than a predetermined value, it is determined that the emotion information in the first voice data is the first emotion information.

Specifically, for example when the user input “How is the weather today?” many times but failed to get the answer all along, this is may be caused by the network failure that the electronic device did not acquire the weather information, so “sorry, no available” is always responded before it is determined that the times of the consecutive input of the first voice data are larger than a predetermined value, thus it is judged that the user feels anxious and even angry. But the electronic device still fails to acquire the weather information, the first response voice data of “sorry, no available” is acquired this time, then the above-mentioned two methods, that is, adjusting the tone, the volume or the pause time between words or adding some voice data expressing a strong apology and regret such as “Very sorry, no available”, can be used to process the first response voice data based on the first emotion information, so that the sentence with the emotion of apology and regret is output to placate the angry user, which will enhance the user's experience.

Next, another example is used to illustrate the detailed process of the method. In the present embodiment, for example, which is applied in an instant message software, in Step 201, what is received is the first voice data such as “Why haven't you finished the work?” input by the user A. It is found that the user A is angry by adopting the analysis method in the above-mentioned embodiments. Then, the first response voice data such as “There are too many works to finish!” with respect to the first voice data of the user A is received from the user B. To avoid the argument between the user A and the user B, since the user A is so angry, the electronic device will process the first response voice data of the user B to relieve that emotion, thus the user A will not become more angry after hearing the response. Likewise, the electronic device on the user B's side can perform the similar process, which will prevent the user A and the user B from making an argument due an agitated emotion so that the humanization of the electronic will improve the user's experience.

The procedure of the method is described hereinabove, and the details relating to how to analyze the emotion and how to adjust the voice data will be understood with reference to the corresponding description in the above-mentioned embodiments. For the sake of brevity, the repeated description is omitted here.

An embodiment of the present invention provides an electronic device, such as a mobile phone, a tablet computer or a notebook computer.

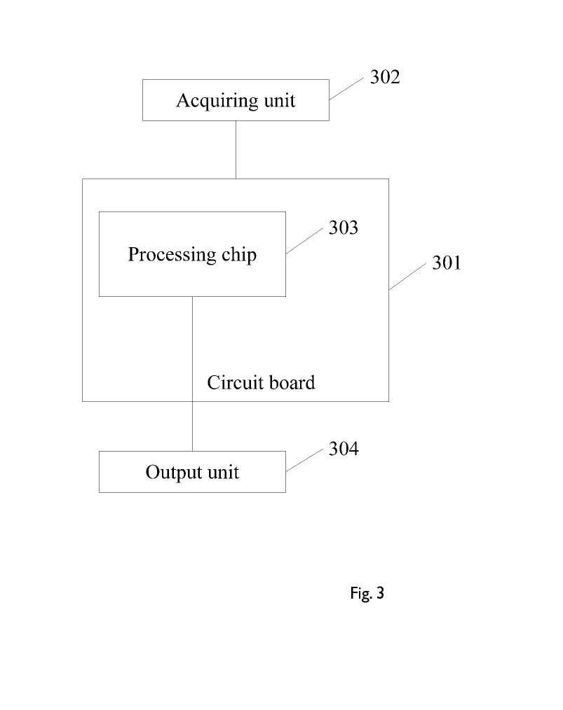

As shown in FIG. 3, the electronic device comprises: a circuit board 301; an acquiring unit 302 electrically connected to the circuit board 301 for acquiring a first content to be output; a processing chip 303 set on the circuit board 301 for analyzing the first content to be output to acquire a first emotion information for expressing the emotion carried by the first content to be output; acquiring a first voice data to be output corresponding to the first content to be output; processing the first voice data to be output based on the first emotion information to generate a second voice data to be output with a second emotion information, wherein the second emotion information is used to express the emotion of the electronic device outputting the second voice data to be output to enable the user to acquire the emotion of the electronic device, and wherein the first emotion information and the second emotion information are matched to/correlated to each other; an output unit 304 electrically connected to the processing chip 303 for outputting the second voice data to be output.

Wherein, the circuit board 301 can be the mainboard of the electronic device, furthermore, the acquiring unit 302 can be a data receiving means or a voice input means such as microphone.

Furthermore, the processing chip 303 can be a separate voice processing chip, or can be integrated into the processor. The output unit 304 is the voice output means such as speaker or horn.

In an embodiment, when the first content to be output is a voice data, the processing chip 303 is used to compare the audio spectrum of the voice data with every characteristic spectrum template among the M characteristic spectrum templates respectively to acquire the M comparison results of the audio spectrum of the voice data against every characteristic spectrum template, wherein M is a integral greater than 2; then the characteristic spectrum template among the M characteristic spectrum templates having the highest similarity with the voice data is determined based on the M comparison results; the emotion information corresponding to the characteristic spectrum template having the highest similarity is determined as the first emotion information.

In another embodiment, the processing chip 303 is used to adjust the tone, the volume of the words corresponding to the first voice data to be output or the pause time between words so as to generate the second voice data to be output.

Various alternative methods and implementations of the voice output method according to the embodiment in FIG. 1 can also applied to the electronic device of the present embodiment. Those skilled in the art will understand the implementation of the electronic device of the present embodiment in view of the detailed description of the voice output method above-mentioned. For the sake of brevity, the repeated description is omitted here.

Another embodiment of the present invention provides an electronic device, such as a mobile phone, a tablet computer or a notebook computer.

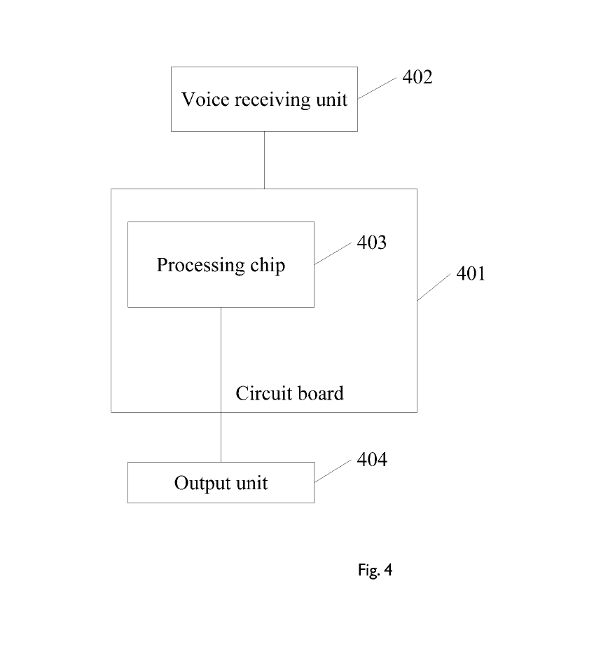

With reference to FIG. 4, the electronic device comprises: a circuit board 401; a voice receiving unit 402 electrically connected to the circuit board 401 for receiving a first voice input of a user; a processing chip 403 set on the circuit board 401 for analyzing the first voice data to acquire a first emotion information, wherein the first emotion information is used to express the emotion of the user when the user input the first voice data; acquiring a first response voice data with respect to the first voice data; processing the first response voice data based on the first emotion information to generate a second response voice with a second emotion information; the second emotion information is used to express the emotion of the electronic device outputting the second voice data to be output to enable the user to acquire the emotion of the electronic device, and wherein the first emotion information and the second emotion information are matched to/correlated to each other; an output unit 404 electrically connected to the processing chip 403 for outputting the second response voice data.

Wherein, the circuit board 401 can be the mainboard of the electronic device, furthermore, the acquiring unit 302 can be a data receiving means or a voice input means such as microphone.

Furthermore, the processing chip 403 can be a separate voice processing chip, or can be integrated into the processor. The output unit 404 is the voice output means such as speaker or horn.

In an embodiment, the processing chip 403 is used to compare the audio spectrum of the first voice data with every characteristic spectrum template among the M characteristic spectrum templates respectively to acquire the M comparison results of the audio spectrum of the voice data against every characteristic spectrum template, wherein M is a integral greater than 2; then the characteristic spectrum template among the M characteristic spectrum templates having the highest similarity with the voice data is determined based on the M comparison results; the emotion information corresponding to the characteristic spectrum template having the highest similarity is determined as the first emotion information.

In another embodiment, the processing chip 403 is used to determine whether the times of the consecutive input are larger than a predetermined value; when the times of the consecutive input are larger than a predetermined value, it is determined that the emotion information in the first voice data is the first emotion information.

In another embodiment, the processing chip 403 is used to adjust the tone, the volume of the words corresponding to the first response voice data or the pause time between words so as to generate the second response voice data.

In another embodiment, the processing chip 403 is used to add the voice data expressing the second emotion information to the first response voice data based on the first emotion information as so to acquire the second response voice data.

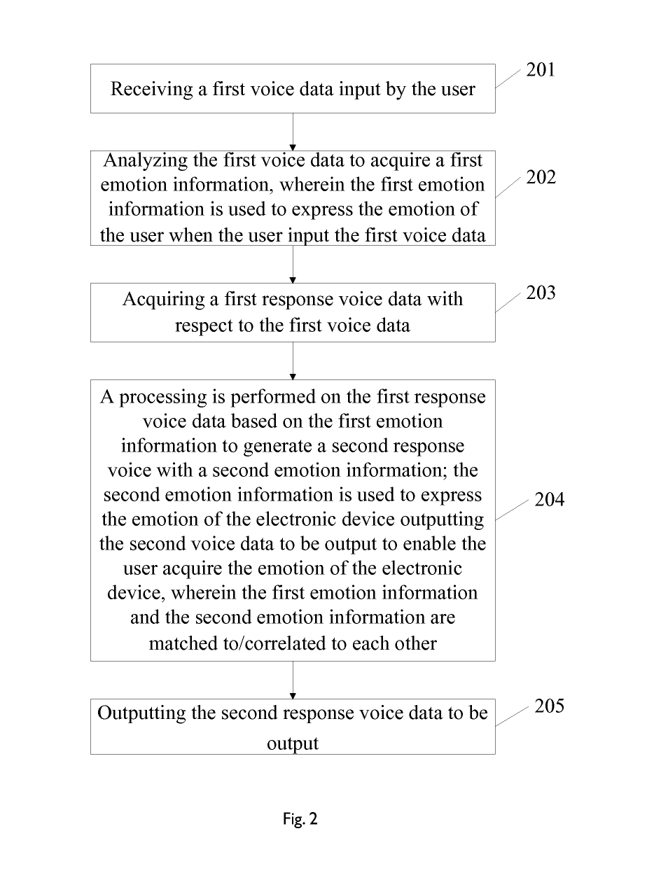

Various alternative methods and implementations of the voice interaction method according to the embodiment in FIG. 2 can also applied to the electronic device of the present embodiment. Those skilled in the art will understand the implementation of the electronic device of the present embodiment in view of the detailed description of the voice output method above-mentioned. For the sake of brevity, the repeated description is omitted here.

The embodiments of the present invention provide one or more technical solutions and at least the technical effects or advantages as follows:

According to an embodiment of the present invention, the emotion information of the content to be output (for example SMS message or other text information, or the voice data received via an instant message software, or the voice data input via the voice input means of the electronic device), then the voice data to be output corresponding to the content to be output is processed based on the emotion information to acquire the voice data to be output with a second emotion information. Thus, when the electronic device outputs the voice data to be output with the second emotion information, the user can acquire the emotion of the electronic device. Therefore, the electronic device can output the voice information with different emotions according to different contents or scenes, which helps the user understand the emotion of the electronic device more clearly, thus the efficiency of the voice output is enhanced and the user's experience is improved.

According to another embodiment of the present invention, when the user inputs a first voice data, the first voice data is analyzed to acquire the corresponding first emotion, and then a first response voice data with respect to the first voice data is acquired. Next, a processing is performed on the first response voice data based on the first emotion information to generate a second response voice with a second emotion information which enable the user to acquire the emotion of the electronic device when the second response voice data is output. Thus, a better Human-Machine interaction is realized and the electronic device is more humanized so that the Human-Machine interaction is efficient and the user's experience is improved.

Through the above description of the embodiments, the skilled in the art can clearly understand that the present invention is achieved through software plus a necessary hardware platform, of course, can also be implemented entirely by hardware. Based on such understanding, the technical solution of the present invention, the background art to contribute to all or a portion may be embodied in the form of a software product, the computer software product may be stored in a storage medium, such as a ROM/RAM, disk, optical disk, etc., comprises a plurality of instructions for a method that allows a computer device (may be a personal computer, server, or network equipment, etc.) to perform various embodiments of the present invention or some portion of the embodiment.

In the embodiment of the invention, the unit/module can be implemented in software for execution by various types of processors. For example, an identification module of executable code may include one or more physical or logical blocks of computer instructions, for example, which can be constructed as an object, procedure, or function. Nevertheless, the identified module of executable code without physically located together, but may include different instructions stored in different bit on, when these instructions are logically combined together, and its constituent units/modules and achieve the unit/modules specified purposes.

Unit/module can be implemented using software, taking into account the level of the existing hardware technology, it can be implemented in software, the unit/module, in the case of not considering the cost of skilled in the art can build the corresponding hardware circuit to achieve the function corresponding to the hardware circuit comprises a conventional ultra-large scale integrated (VLSI) circuit or a gate array, such as logic chips, existing semiconductor of the transistor and the like, or other discrete components. The module may further with the programmable hardware device, such as a field programmable gate array, programmable array logic, programmable logic devices, etc. to achieve.

It should be understood by those skilled in the art that various modifications, combinations, sub-combinations and alterations may occur depending on design requirements and other factors insofar as they are within the scope of the appended claims or the equivalents thereof.

1. A voice output method applied in an electronic device, characterized in that, the method comprises:
acquiring a first content to be output;
analyzing the first content to be output to acquire a first emotion information for expressing the emotion carried by the first content to be output;
acquiring a first voice data to be output corresponding to the first content to be output;
processing the first voice data to be output based on the first emotion information to generate a second voice data to be output with a second emotion information, wherein the second emotion information is used to express the emotion of the electronic device outputting the second voice data to be output to enable the user to acquire the emotion of the electronic device, and wherein the first emotion information and the second emotion information are matched to/correlated to each other;
outputting the second voice data to be output.

2. The method according to claim 1, characterized in that, acquiring a first content to be output is:
acquiring the voice data received via a instant message application;
acquiring the voice data input via the voice input means of the electronic device; or
acquiring the text information displayed on the display unit of the electronic device.

3. The method according to claim 2, characterized in that, when the first content to be output is the voice data, analyzing the first content to be output to acquire a first emotion information comprises:
comparing the audio spectrum of the voice data with every characteristic spectrum template among the M characteristic spectrum templates respectively to acquire the M comparison results of the audio spectrum of the voice data against every characteristic spectrum template, wherein M is a integral greater than 2;
determining the characteristic spectrum template among the M characteristic spectrum templates having the highest similarity with the voice data based on the M comparison results;
determining the emotion information corresponding to the characteristic spectrum template having the highest similarity as the first emotion information.

4. The method according to claim 1, characterized in that, processing the first voice data to be output based on the first emotion information to generate a second voice data to be output with a second emotion information comprises:
adjusting the tone, the volume of the words corresponding to the first voice data to be output or the pause time between words to generate the second voice data.

5. A voice interaction method applied in an electronic device, characterized in that, the method comprises:
receiving a first voice data input by a user;
analyzing the first voice data to acquire a first emotion information, wherein the first emotion information is used to express the emotion of the user when the user input the first voice data;
acquiring a first response voice data with respect to the first voice data;
processing the first response voice data based on the first emotion information to generate a second response voice data with a second emotion information; the second emotion information is used to express the emotion of the electronic device outputting the second voice data to be output to enable the user to acquire the emotion of the electronic device, and wherein the first emotion information and the second emotion information are matched to/correlated to each other;
outputting the second response voice data.

6. The method according to claim 5, characterized in that, analyzing the first voice data to acquire a first emotion information comprises:
comparing the audio spectrum of the first voice data with every characteristic spectrum template among the M characteristic spectrum templates respectively to acquire the M comparison results of the audio spectrum of the voice data against every characteristic spectrum template, wherein M is a integral greater than 2;
determining the characteristic spectrum template among the M characteristic spectrum templates having the highest similarity with the voice data based on the M comparison results;
determining the emotion information corresponding to the characteristic spectrum template having the highest similarity as the first emotion information.

7. The method according to claim 5, characterized in that, analyzing the first voice data to acquire a first emotion information comprises:
determining whether the times of the consecutive input are larger than a predetermined value;
when the times of the consecutive input are larger than a predetermined value, determining the emotion information in the first voice data as the first emotion information.

8. The method according to claim 5, characterized in that, processing the first response voice data based on the first emotion information to generate a second response voice data with a second emotion information comprises:
adjusting the tone, the volume of the words corresponding to the first response voice data to be output or the pause time between words to generate the second response voice data.

9. The method according to claim 5, characterized in that, processing the first response voice data based on the first emotion information to generate a second response voice data with a second emotion information comprises:
adding the voice data expressing the second emotion information to the first response voice data based on the first emotion information to acquire the second response voice data.

10. An electronic device, characterized in that, the electronic device comprises:
a circuit board;
an acquiring unit electrically connected to the circuit board for acquiring a first content to be output;
a processing chip set on the circuit board for analyzing the first content to be output to acquire a first emotion information for expressing the emotion carried by the first content to be output; acquiring a first voice data to be output corresponding to the first content to be output; processing the first voice data to be output based on the first emotion information to generate a second voice data to be output with a second emotion information, wherein the second emotion information is used to express the emotion of the electronic device outputting the second voice data to be output to enable the user to acquire the emotion of the electronic device, and wherein the first emotion information and the second emotion information are matched to/correlated to each other;
an output unit electrically connected to the processing chip 303 for outputting the second voice data to be output.

11. The electronic device according to claim 10, characterized in that, when the first content to be output is the voice data, the processing chip is used to compare the audio spectrum of the voice data with every characteristic spectrum template among the M characteristic spectrum templates respectively to acquire the M comparison results of the audio spectrum of the voice data against every characteristic spectrum template, wherein M is a integral greater than 2; determine the characteristic spectrum template among the M characteristic spectrum templates having the highest similarity with the voice data based on the M comparison results; determine the emotion information corresponding to the characteristic spectrum template having the highest similarity as the first emotion information.

12. The electronic device according to claim 10, characterized in that, the processing chip is used to adjust the tone, the volume of the words corresponding to the first voice data to be output or the pause time between words to generate the second voice data.

13. An electronic device, characterized in that, the electronic device comprises:
a circuit board;
a voice receiving unit electrically connected to the circuit board for receiving a first voice input of a user;
a processing chip set on the circuit board for analyzing the first voice data to acquire a first emotion information, wherein the first emotion information is used to express the emotion of the user when the user input the first voice data; acquiring a first response voice data with respect to the first voice data; processing the first response voice data based on the first emotion information to generate a second response voice with a second emotion information; the second emotion information is used to express the emotion of the electronic device outputting the second voice data to be output to enable the user to acquire the emotion of the electronic device, and wherein the first emotion information and the second emotion information are matched to/correlated to each other;
an output unit electrically connected to the processing chip for outputting the second response voice data.

14. The electronic device according to claim 13, characterized in that, the processing chip is used to compare the audio spectrum of the first voice data with every characteristic spectrum template among the M characteristic spectrum templates respectively to acquire the M comparison results of the audio spectrum of the voice data against every characteristic spectrum template, wherein M is a integral greater than 2; determine the characteristic spectrum template among the M characteristic spectrum templates having the highest similarity with the voice data based on the M comparison results; determine the emotion information corresponding to the characteristic spectrum template having the highest similarity as the first emotion information.

15. The electronic device according to claim 13, characterized in that, the processing chip is used to determine whether the times of the consecutive input are larger than a predetermined value; when the times of the consecutive input are larger than a predetermined value, determine the emotion information in the first voice data as the first emotion information.

16. The electronic device according to claim 13, characterized in that, the processing chip is used to adjust the tone, the volume of the words corresponding to the first response voice data to be output or the pause time between words to generate the second response voice data.

17. The electronic device according to claim 13, characterized in that, the processing chip is used to add the voice data expressing the second emotion information to the first response voice data based on the first emotion information to acquire the second response voice data.
